(19) United States
(12) Patent Application Publication
(10) Pub. No.: US 2006/0138368 A1
(43) Pub. Date: Jun. 29, 2006

(54) Apparatus and method for inspecting semiconductor wafers for metal residue

(76) Inventor: Jin Kyoo Lee, Bucheon-city (KR)

Correspondence Address: THE LAW OFFICES OF ANDREW D. FORTNEY, PH.D., P.C., 7257 N. MAPLE AVENUE, BLDG. D, SUITE 107, FRESNO, CA, 93720, US

(21) Appl. No.: 11/321,091

(22) Filed: Dec. 28, 2005

(30) Foreign Application Priority Data
Dec. 29, 2004 (KR) 10-2004-0115657

(51) Int. Cl. G01N 21/88

(52) U.S. Cl. 250/559.45

(57) ABSTRACT

An apparatus and method for inspecting metal residue is disclosed, in which the metal residue and its residual thickness are effectively inspected after a chemical mechanical polishing (CMP) process. The apparatus for inspecting metal residues includes a light emitter emitting light having a certain wavelength to a surface of a semiconductor substrate, a light detector receiving light reflected from the surface, and an output device configured to produce a signal corresponding to one or more wavelengths of said reflected light. Thus, it is possible to determine the presence and/or thickness of metal residue using the wavelength or wavelengths of the reflected light.

This application claims the benefit of the Korean Patent Application No. P2004-0115657, filed on Dec. 29, 2004, which is hereby incorporated by reference as if fully set forth herein.

### FIELD OF THE INVENTION

The present invention relates to an apparatus and method for manufacturing a semiconductor device, and more particularly, to an apparatus and method for inspecting metal residues such as tungsten and copper after a chemical mechanical polishing (CMP) process.

### DISCUSSION OF THE BACKGROUND

A chemical mechanical polishing (CMP) process means that a surface of a wafer is polished by a combination of chemical reaction and mechanical force. The CMP process is classified into an oxide CMP process (e.g., a CMP process applied to a semiconductor oxide layer, particularly a SiO₂ layer) and a metal CMP process (e.g., a CMP process applied to one or more metal layers). The oxide CMP process is widely used for interlayer planarization or interlayer insulation of an oxide layer of a semiconductor device. This is due to a design rule of a semiconductor device that requires beams having a short wavelength to form a fine pattern (e.g., CMP might be necessary in order to bring the entire surface within the depth of field of a photolithography system). In other words, it is necessary to perfectly planarize a semiconductor device miniaturized by decrease of an exposure margin.

Meanwhile, the metal CMP process may be used in a damascene process for forming a line film, or in a dual damascene process for simultaneously forming a plug and a line film on the plug. In a conventional damascene or dual-damascene process, standard lithographic techniques are first used to etch troughs or holes in an oxide layer of the semiconductor substrate. Next, a layer or layers of metal are deposited over the semiconductor substrate. This process fills the holes and/or trenches, but also leaves residual metal on the surface of the semiconductor substrate. CMP is used to remove the metal from the surface of the substrate, while leaving the troughs or holes filled. A CMP apparatus that performs the aforementioned CMP processes includes a wafer carrier that supports a wafer having a film material to be polished, and a polishing pad that polishes the wafer using slurry.

Metal residue may remain after the metal CMP process due to inaccuracy in detection of an end point or deterioration of a polishing ratio. The metal residue may not be completely removed even by a cleaning process after the CMP process. The residual metal may cause an undesirable electrical bridge between components of the semiconductor. One method of reducing metal residues is to overpolish a metal layer during the metal CMP process. In the metal CMP process, since polishing particles are relatively large, a polishing ratio of the metal layer is greater than that of an insulating layer below the metal layer. Therefore, the insulating layer may serve as a polishing stopper (or “polish stop”) in the metal CMP process.

However, in case where the metal layer is excessively polished, problems may occur. The stopping effect of the insulating layer positioned below the metal layer may be more pronounced in a sparse medium or feature region than in a dense medium or feature region. Therefore, the insulating layer may vary in thickness after the metal CMP process. This may reduce reliability of the semiconductor device.

Therefore, it is necessary to completely remove the metal layer without excessively polishing the metal layer. To this end, a method for inspecting a semiconductor wafer for metal residue has been studied.

Conventionally, a process for inspecting a semiconductor wafer for metal residue may be performed after the CMP process. That is, wafers may be inspected one by one using an inspection method with the naked eye using a microscope. However, the conventional inspection method has limitation in inspecting or detecting a metal film or residues having a very thin thickness.

Another conventional inspection method may be performed using a separate defect inspection apparatus. In this method, an image of a standard chip in a wafer may be compared with an image of a sample chip using the separate defect inspection apparatus. However, if all the wafers are inspected using this defect inspection apparatus, the time required for the inspection increases as the number of chips increases. This may deteriorate productivity. Alternatively, only sample wafers from a batch or lot of wafers may be inspected. In this case, the defect inspection apparatus may regard all of the wafers in a batch or lot as defective if the image of the standard chip is different from the image of the sample chip. In this case, a problem arises in that additional thorough inspection is required to determine whether the wafer is representative of the batch or lot.

Therefore it is desirable to implement a method for detecting residual metal during a CMP process with high wafer throughput.

### SUMMARY OF THE INVENTION

Accordingly, the present invention is directed to an apparatus and method for inspecting a semiconductor wafer for metal residue, which substantially obviates one or more problems due to limitations and disadvantages of the related art.

An object of the present invention is to provide an apparatus and method for inspecting semiconductor wafers for metal residue, in which the presence and/or thickness of metal residue are effectively determined after a chemical mechanical polishing (CMP) process.

Additional advantages, objects, and features of the invention will be set forth in part in the description which follows and in part will become apparent to those having ordinary skill in the art upon examination of the following, or may be learned from practice of the invention. The objectives and other advantages of the invention may be realized and attained by the structure(s) and/or example(s) particularly pointed out in the written description and claims hereof as well as the appended drawings.

To achieve these objects and other advantages and in accordance with the purpose of the invention, as embodied and broadly described herein, an apparatus for inspecting semiconductor wafers for metal residue includes a light emitter configured to emit light having a certain wavelength to a surface of a semiconductor substrate (or wafer), a light detector receiving light reflected from the surface, and an output device configured to produce a signal corresponding to one or more wavelengths of the reflected light.

In a further embodiment, the apparatus may include an image output unit configured to produce an image displaying the detected wavelengths. The image output unit may comprise a spectrometer. The wavelength or wavelengths displayed by the spectrometer may be used to determine the presence and/or thickness of the metal residue.

The light detector may include a polarizing filter through which the reflected light is received.

The apparatus may further include a light source, wherein the light emitter is configured to receive an output of the light source. The emitter may emit the light produced by the light source or a filtered subset or subbands(s) of the wavelengths produced by the light source.

The apparatus may further include a light transmitter configured to transmit the output of the light source to the light emitter. The light transmitter may comprise either a single light fiber or a bundle of split light fibers to minimize light loss.

The light emitter and the light detector may be housed in a single body. The light emitter and the light detector may, either separately or as a single unit, traverse an axis of the surface of the wafer, thereby scanning for metal residue across the entire surface. The movement of emitter and light detector may be controlled by a microcontroller. The microcontroller may be configured to scan the surface at a certain speed.

The light detector may emit light having a wavelength in the range of 400 nm to 890 nm. The wavelength or wavelengths emitted may be chosen according to the metal to be detected. The metal residue may comprise at least one member selected from the group consisting of tungsten, titanium, titanium nitride, tantalum, tantalum nitride, copper, and aluminum.

In a preferred embodiment, the metal residue detecting apparatus may be a component in a CMP apparatus. Such a configuration advantageously facilitates application of an additional CMP process to remove residual metal if metal residue is detected.

In another aspect of the present invention, a method for inspecting metal residue on a surface of a semiconductor substrate includes the steps of (a) chemical mechanical polishing a metal film on the surface (b) emitting light having a certain wavelength to the surface, (c) detecting light reflected from the surface, (d) outputting a signal corresponding to one or more wavelengths of the reflected light, and (e) correlating a value of the signal to a presence and/or absence of residual metal.

The emitting step may include the steps of transmitting the light having a certain wavelength from a light source to a light emitter (e.g., through a single light fiber or a bundle of split light fibers), and emitting the light transmitted through the light emitter to the upper layer of the wafer.

In another embodiment the emitting step may include traversing an axis of the surface of the semiconductor substrate with the emitter. The entire surface of the substrate may be scanned thereby.

In a further embodiment, the method may include an additional chemical mechanical polishing step if residual metal is detected.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle(s) of the invention. In the drawings:

FIG. 1A is a graph of wavelengths of light reflected by a tungsten film with a thickness of 6000 Å.

FIG. 1B is a graph of wavelengths of light reflected by a tungsten film with a thickness of 3000 Å.

FIG. 1C is a graph of wavelengths of light reflected by a tungsten film with a thickness of 700 Å.

FIG. 2 depicts common residual metal film patterns, with corresponding graphs of reflected light as measured in accordance with an embodiment of the present invention.

FIG. 3 illustrates a side view of an apparatus for inspecting semiconductor wafers for metal residue in accordance with an embodiment of the present invention.

FIG. 4 illustrates a top down view of an apparatus for inspecting semiconductor wafers for metal residue in accordance with an embodiment of the present invention.

FIG. 5 is a flowchart of an exemplary method of inspecting a semiconductor wafer for metal residue according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

For the sake of convenience and simplicity, the terms “wafer” and “semiconductor substrate” are generally used interchangeably herein, but are generally given their art-recognized meanings. Also, for convenience and simplicity, the terms “connected to,” “coupled with,” “coupled to” and “in communication with” may be used interchangeably, but these terms are also generally given their art-recognized meanings.

Generally, examples of materials for forming a semiconductor device include materials for an oxide film, such as Si, PETEOS, BPSG, PSG, FSG, and SRO, and metal materials for forming a conductive line and a plug, such as Al, Cu, Al—Cu, W, Ti, and TiN. Since each of the metal materials has unique reflectivity to light, the light reflected from the metal materials has a unique wavelength of a certain range depending on the metal materials. Also, the light reflected from one metal material has a variable wavelength depending on the thickness of the metal material. An apparatus and method for inspecting semiconductor wafers for metal residue in accordance with the present invention is based on the above principles. In the apparatus and method for inspecting semiconductor wafers for metal residue in accordance with the present invention, a wavelength of light reflected from the surface of a semiconductor wafer and/or the intensity and/or absorption of such light is measured to determine the presence, absence, and/or thickness of any metal residue on the surface of the wafer or other substrate.

Hereinafter, a preferred embodiment of the present invention will be described with reference to the accompanying drawings. In the preferred embodiment of the present invention, although the metal residue may comprise tungsten (W) residue, the present invention is not limited to inspection or detection of tungsten residue. Also, various modifications can be made to the embodiments of the present invention. The following embodiments are exemplary and are not to be construed as limiting the present invention.

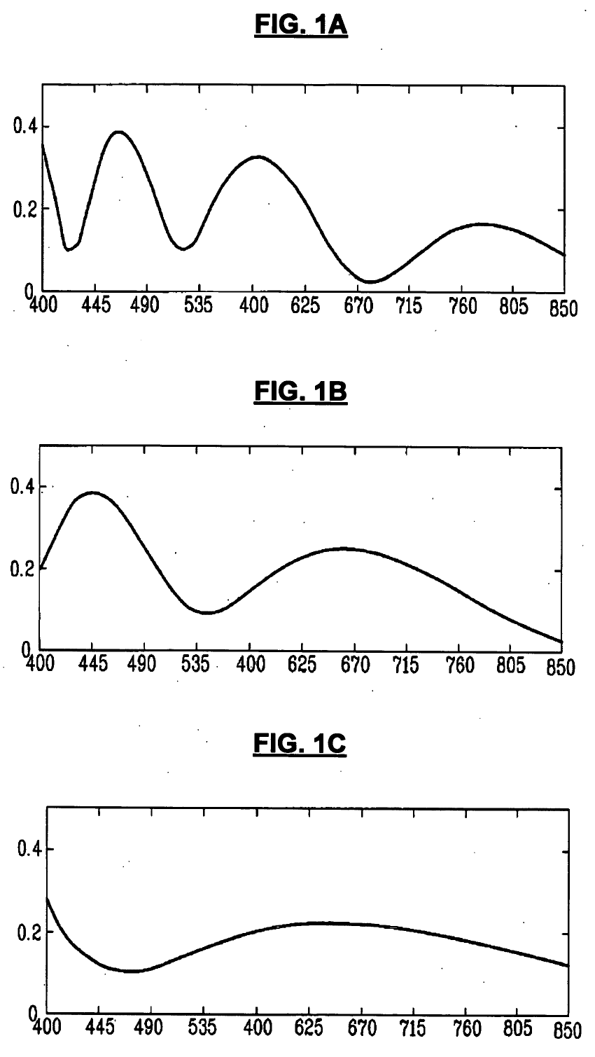

FIG. 1A to FIG. 1C illustrate a wavelength of reflecting light depending on thickness of a tungsten film.

Referring to FIG. 1A to FIG. 1C, after a CMP process is performed for a tungsten film on a wafer, light is emitted to a surface of the wafer, and the resulting reflected light is inspected. In this case, if tungsten residue remains, as shown in FIG. 1A to FIG. 1C, the wavelengths of reflected light may vary, depending on the thickness of the tungsten residue. FIGS. 1A-1C show reflected wavelengths where the tungsten residue has a thickness of 6000 Å, 3000 Å, and 700 Å, respectively.

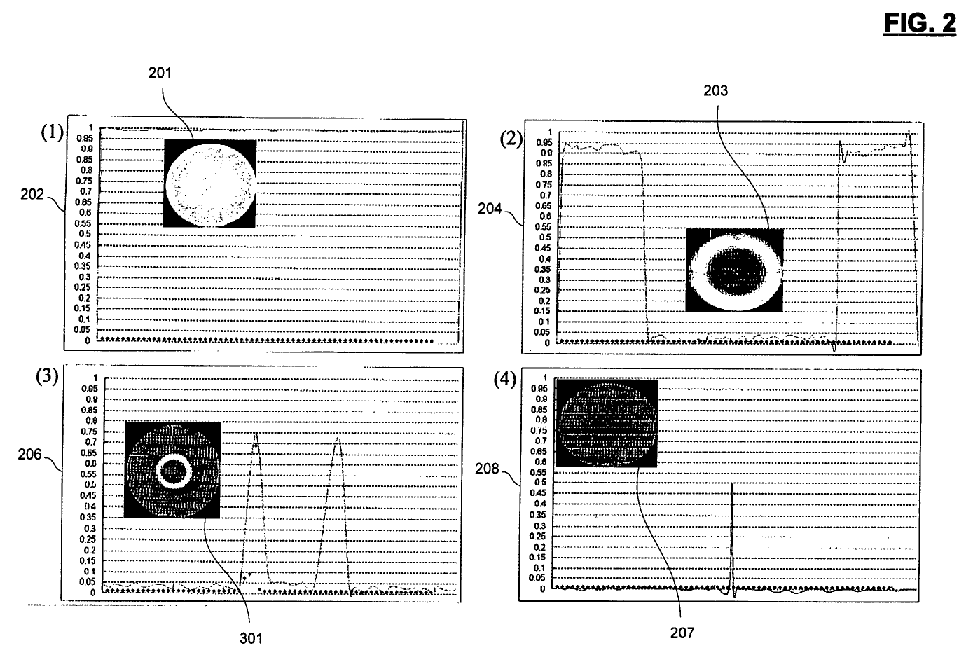

Referring now to FIG. 2, several reflection patterns are shown which indicate the presence or absence of residual metal. Wafer 201 is entirely coated with residual metal, resulting in a graph 202 wherein the reflected light level at a given wavelength is at or near the maximum value (e.g. at or about “1”) over the entire length of the wafer. On wafer 203 residual metal is present on the edges of the wafer, but absent in the center of the wafer, resulting in a graph 204 wherein the reflected light level is near the maximum value at the beginning and end of the graph, but at or near a minimum value (e.g., about “0”) in the middle of the graph. Wafer 205 has residual metal in a circular pattern on the wafer, resulting in a graph 206 wherein the reflected light level is at a relatively high value at points on the graph corresponding to the radius or diameter of the ring relative to the radius or diameter of the wafer. Wafer 207 has residual metal at a spot in the center of the wafer, resulting in graph 208 with a spike in the reflected light measurement at the center of the graph. The determination of the presence or absence of residual metal according to the present invention may involve a comparison to one or more known defect patterns such as these.

Furthermore, the presence and/or thickness of metal residue can be measured promptly and effectively based on the principle that different wavelengths may be detected depending on the thickness of the metal residue.

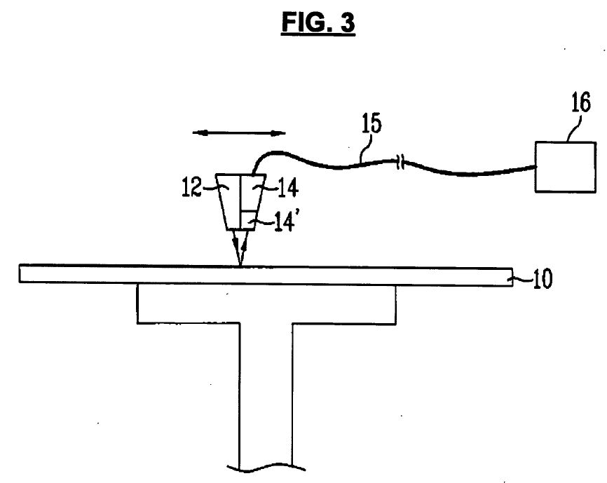

FIG. 3 illustrates an exemplary apparatus for inspecting or detecting metal residue in accordance with the present invention.

As shown in FIG. 3, an apparatus for inspecting metal residue in accordance with the present invention may include a light emitter 12 emitting light having a certain wavelength on a surface of a semiconductor wafer 10, a light detector 14 receiving light reflected from the surface through an optional polarizing filter 14′, an image output unit 16 having a spectrometer that outputs a wavelength of the reflecting light received by the light detector 14 in images, and a reflected light transmitter 15, serving as a light path between the light detector 14 and the image output unit 16. Reflected light transmitter 15 may advantageously comprise a single light fiber or a bundle of split light fibers to minimize light loss.

Furthermore, the image output unit 16 may include a light source (not shown). The light emitter 12 may emit light having a certain wavelength from the light source to the surface of the wafer 10. The light from the light source may have a wavelength in the range of 400 nm to 890 nm.

Meanwhile, in the preferred embodiment of the present invention, the light emitter 12 and the light detector 14 may be provided in a single body and controlled by a microcontroller (not shown) to scan the wafer 10 at a certain speed along an axis of the surface (e.g. a diameter or radius) of the wafer. The microcontroller may be provided in the image output unit 16 or may be separately provided.

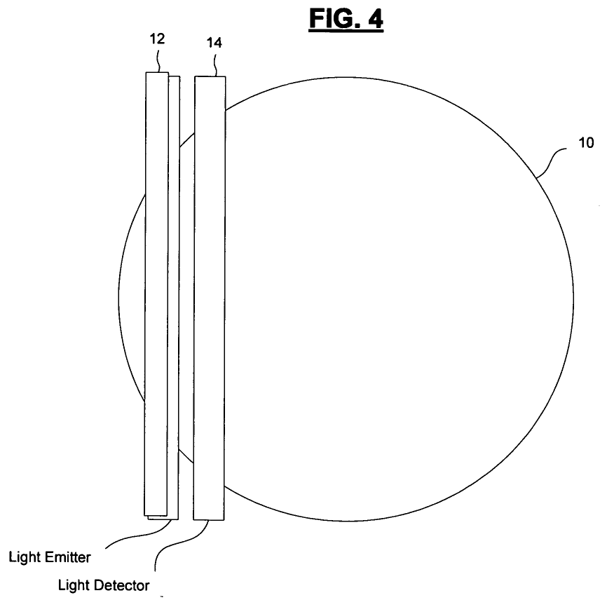

Referring now to FIG. 4, a top view of an alternative apparatus for inspecting metal residue in accordance with the present invention is shown. Light emitter 12 may emit light on a surface of semiconductor wafer 10, and light detector 14 may receive light reflected from that surface. In this case, the apparatus may scan across the entire surface of the wafer or substrate, and a two-dimensional plot of the detected property of the reflected light (e.g., indicating whether the detected property is above or below a predetermined threshold value, or between two predetermined threshold values) according to the locations on the wafer or substrate may be generated.

The operation of a preferred embodiment for inspecting semiconductor wafers for metal residue in accordance with the present invention will be described as follows.

After a metal CMP process used for a damascene process for forming a metal line is performed, the microcontroller controls the light emitter 12 so as to scan the wafer 10 along an axis of the surface of the wafer, and emit the light having a certain wavelength from the light source. Light transmission from the light source to the light emitter 12 is performed through the light transmitter 15.

Next, the light emitted from the light emitter 12 is reflected on the surface of the wafer 10 and enters the light detector 12. Since the light detector 14 may be provided in a single body with the light emitter 12, it traverses the axis of the semiconductor wafer along with the light emitter 12, and receives the light reflected from the surface the wafer substantially concurrently with the light emitter 12 emitting the light. The light detector 14 transmits the received reflecting light to the image output unit 16 through the light transmitter 15. Meanwhile, the light detector 14 may include a polarizing filter 14′. The polarizing filter 14′ may selectively filter light depending on wavelength.

The image output unit 16 that has received the reflecting light through the light transmitter 15 may calculate the wavelength of the reflecting light using a spectrometer, and output the calculated wavelength of the reflecting light in images through a display device (not shown) such as LCD. Thus, it is possible to determine whether the metal residue remains, along with the thickness of the metal residues.

For example, in case of a wafer in which amorphous metal residue remains, a wavelength of the metal residue may be detected by the light detector. In case of a wafer in which metal residue does not remain, a wavelength corresponding to metal residue is not detected. Therefore, it is possible to determine whether metal residue remains. Also, it is possible to determine the residual thickness.

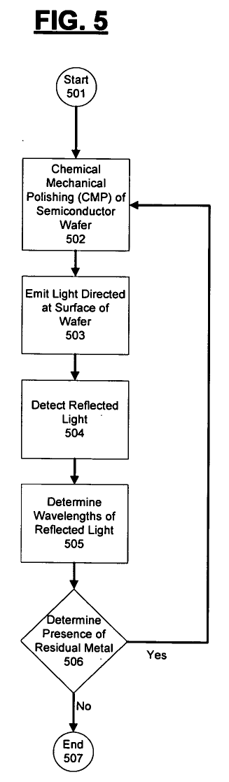

Referring now to FIG. 5, an exemplary method of inspecting a semiconductor wafer for metal residue is shown. At the start of the process 501, a wafer with a metal film thereon may be placed into a CMP apparatus. CMP may then be performed on the wafer 502. Following CMP, light may be emitted towards the surface of the wafer 503, and the presence or absence of light (or its wavelength, intensity, etc.) reflected from the surface of the wafer may be detected 504. The wavelength or wavelengths of the reflected light may then be determined in step 505. The wavelength or wavelengths detected may be compared to wavelengths that would be reflected by residual metal to determine in step 406 the presence or absence of residual metal. If residual metal is detected, CMP (step 502) may be performed again. If no residual metal is detected, then CMP of the wafer is complete (see end [or result] 507) with respect to removing the metal film.

As described above, the apparatus and method for detecting metal residue according to the present invention advantageously provides for prompt and effective detection of the presence and/or thickness of metal residue on the entire region of the wafer, including a pattern region and a wafer edge exclusion (WEE) region. It is possible to improve productivity through automation.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for inspecting metal residue on a surface of a semiconductor substrate, said apparatus comprising:
a light emitter configured to emit light having a certain wavelength to said surface;
a light detector receiving reflected light from said surface; and
an output device configured to produce a signal corresponding to one or more properties of said reflected light.

2. The apparatus as claimed in claim 1, further comprising an image output unit configured to produce an image, said image displaying said one or more properties of said reflected light.

3. The apparatus as claimed in claim 1, further comprising a polarizing filter configured to filter said reflected light.

4. The apparatus as claimed in claim 1, further comprising a light source, said light emitter configured to receive an output of said light source.

5. The apparatus as claimed in claim 4, further comprising a light transmitter, configured to transmit said output of said light source to said light emitter.

6. The apparatus as claimed in claim 1, further comprising a reflected light transmitter configured to transmit said reflected light from said light detector to said output device.

7. The apparatus as claimed in claim 6, wherein said light transmitter comprises a single light fiber or a bundle of split light fibers.

8. The apparatus as claimed in claim 2, wherein said image output unit comprises a spectrometer.

9. The apparatus as claimed in claim 1, said light emitter and said light detector housed in a single body.

10. The apparatus as claimed in claim 1, said light emitter and said light detector configured to traverse an axis of said surface.

11. The apparatus as claimed in claim 1, wherein said emitted light has a wavelength in the range of 400 nm to 890 nm.

12. The apparatus as claimed in claim 1, wherein said one or more properties of said reflected light comprise a wavelength and/or intensity of said reflected light.

13. A chemical mechanical polishing apparatus comprising the apparatus of claim 1.

14. The apparatus as claimed in claim 1 wherein said metal residue comprises at least one member selected from the group consisting of tungsten, titanium, titanium nitride, tantalum, tantalum nitride, copper, and aluminum.

15. A method for inspecting metal residue on a surface of a semiconductor substrate, said method comprising the steps of:
a) emitting light having a certain wavelength to said surface;
b) detecting light reflected from said surface;
c) outputting a signal corresponding to one or more properties of said reflected light; and
d) correlating a presence and/or absence of residual metal on said surface to a value of said signal.

16. The method as claimed in claim 15, wherein said emitted light has a wavelength in the range of 400 nm to 890 nm.

17. The method as claimed in claim 15, wherein said emitting step comprises transmitting said light from a light source to said light emitter.

18. The method as claimed in claim 17, wherein said transmitting step comprises transmitting said light through a single light fiber or a bundle of split light fibers.

19. The method as claimed in claim 15 wherein said residual metal comprises at least one member selected from the group consisting of tungsten, titanium, titanium nitride, tantalum, tantalum nitride, copper, and aluminum.

20. The method as claimed in claim 15, wherein said emitting step further comprises traversing an axis of said surface with said emitter.

21. The method as claimed in claim 15, further comprising additional chemical mechanical polishing if residual metal is present according to the correlating step.

22. The method as claimed in claim 15, further comprising chemical mechanical polishing a metal film on said surface.

23. The method as claimed in claim 15, wherein said one or more properties of said reflected light comprise a wavelength and/or intensity of said reflected light.

24. A process for fabricating a semiconductor wafer, said process comprising:
a) applying a layer of metal to a surface of said semiconductor substrate;
b) polishing a portion of said metal off of said surface;
c) directing light from a light source at said wafer;
d) measuring, with a light detector, reflected light from said surface; and
e) determining a presence or absence of residual metal from said measured reflected light.
